(19) United States
(12) Patent Application Publication
(10) Pub. No.: US 2023/0206350 A1
(43) Pub. Date: Jun. 29, 2023

(54) Lost and Found Social Networking

(71) Applicant: AMI Holdings Limited, Hamilton (BM)

(72) Inventor: Ronen Benchetrit, London (GB)

(21) Appl. No.: 18/083,781

(22) Filed: Dec. 19, 2022

Related U.S. Application Data
(60) Provisional application No. 63/294,541, filed on Dec. 29, 2021.

(51) Int. Cl. G06Q 50/00; H04L 67/306; G06F 18/22

(52) U.S. Cl. CPC G06Q 50/01; G06F 18/22; H04L 67/306

(57) ABSTRACT

Methods, systems, and apparatus, including computer programs encoded on computer storage media, for identifying a lost acquaintance. In some implementations, a server receives a request from a first client device associated with a first user to enter a lost and found function in a social networking application. The server obtains items that describe a prior encounter between the first user and a different user. The server identifies potential candidates from among potential candidates in the lost and found function that match to the different user. The server provides data indicative of the potential candidates to the first client device. The server receives a connection request to one potential candidate from the first client device. The server transmits a first notification to a second client device associated with the one potential candidate. The server receives a request from the first client device to match with the second client device.

### CROSS-REFERENCE TO RELATED APPLICATION

This application claims the benefit of U.S. Provisional Application No. 63/294,541, and titled “Lost and Found Social Networking,” which is incorporated by reference.

### TECHNICAL FIELD

This specification generally relates to networking applications, and more specifically, social networking applications deployed in computer networks.

### BACKGROUND

Social networking applications enable individuals to match to other individuals with a goal of developing a personal, professional, or romantic relationship. After two individuals connect in a match, the matched individuals may communicate with one another electronically using the social networking application.

### SUMMARY

The techniques described in this specification enable users in a social networking environment to match to other individuals. In some implementations, each user in the social networking environment can access a social networking application to generate a profile that characterizes that user. The profile can illustrate a name of the user, one or more photos of the user, their interests, location, and/or other characteristics that represent the user. In some implementations, a user in the social networking application can view profiles of other users. The user may be referred to as the “requesting user.” In response to reviewing the profiles of other users, the requesting user can request a match with one or more other users, the one or more other users may be referred to as the “reviewing users.” Additionally or alternatively, the reviewing user or users may view the profile of the requesting user and in response, decide to match with the requesting user. A selection engine, situated at a server between client devices associated with the requesting user and the reviewing user(s), can receive the request to match from one or both client devices and can facilitate network communications between these two users. In response, the two users can communicate with one another in the social network environment over the network communications.

In some implementations, the social networking application can provide enhanced capabilities for users seeking to connect and communicate with potential matches. The social networking application can provide users with a lost and found function, for example, that offers user the opportunity to search for and identify previously met acquaintances. A first user may meet a second user in real life, and seek to connect with that user through the social networking application. For example, a user may search for an old from college or an individual with whom they crossed paths at a conference. The lost and found function enables the first user to try to remedy the lost and found situation and search for the second user based on criteria. The criteria may include a time, a date, a context of when the prior meeting between the two individuals took place, or other criteria characterizing the prior meeting. Additionally, the criteria can include relevant information about the two individuals—their personality interests, career, age, schools attended, or other information. To ensure personal security for the users, the system can suggest a progressive revealing approach, e.g., user A and user B can reveal small amount of information progressively, increasing the amount of information to be revealed as the two users become more and more confident of the match, until there is a high likelihood or event certainty that the identified user is in fact the lost and found user.

For example, the user A seeking another user (which we will call “user B”) can provide initial criteria of the user they are seeking to reconnect with over the social networking application. The system can search through its database based on the provided initial criteria to identify candidates that potentially match to user B. The system can provide these potential candidates for user A’s review, and user A may select one of the candidates that they believe to be user B. In response, the system notifies user B of the potential connection with user A, and can provide information about user A’s profile that user A has consented to share. At this point, user B can decide to decline the connection, or if they so choose, user B can reveal a portion of their own profile information to user A. The system then provides the information revealed by user B to user A, at which point user A can decline the connection, e.g., because it turns out that user B is not the person user A was searching for, or user A can reveal additional profile information to help user B with the confidence that they know user A. This back-and-forth progressively revealing process of profile information continues until a connection between the parties is agreed to or declined by one or both of user A and user B. By revealing profile information in a consenting and progressive manner, privacy is facilitated for both users. If both parties decide to match, then the system matches the two users to communicate in the social networking application.

In one general aspect, a method performed by a server includes: receiving, by a server, a request from a first client device associated with a first user to enter a lost and found function in a social networking application; obtaining, by the server from the first client device, one or more items that describe a prior encounter between the first user and a different user; identifying, by the server, one or more potential candidates from among a plurality of potential candidates in the lost and found function that match to the different user, the one or more potential candidates identified by comparing characteristics for each candidate of the plurality of potential candidates to the obtained one or more items; providing, by the server, data indicative of the one or more potential candidates to the first client device, wherein the data indicative of the one or more potential candidates includes a first set of information describing each of the potential candidates; receiving, by the server, a connection request to one potential candidate of the one or more potential candidates from the first client device; transmitting, by the server, a first notification to a second client device associated with the one potential candidate, the first notification including (i) an indication that the first user associated with the first client device requests to open a communication channel with the second client device of the one candidate and (ii) a second set of information describing the first user; receiving, by the server, a second notification from the second client device indicating the one potential candidate requests to reveal a third set of information to the first user; transmitting, by the server, a third notification to the first client device, the third notification including the third set of information describing the one potential candidate; and receiving, by the server, a request from the first client device to match with the second client device and open the communication channel.

Other embodiments of these and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, wherein obtaining the one or more items that describe a prior encounter between the first user and the different user includes: providing, by the server, a user interface to the first client device for the lost and found function that enables the first user to search for other users based on information about the prior encounter associated with the other users; and obtaining, by the server, the one or more items that describe the prior encounter between the first user and the different user, wherein the first user provides the one or items as input into the user interface and the one or more items includes at least one of a name of the different user, a school attended by the different user, a last known location of the different user, an age range of the different user, interests of the different user, and other information defining the different user, and the different user shared the prior encounter with the first user.

In some implementations, wherein identifying the one or more potential candidates from among the plurality of potential candidates in the lost and found function that match to the different user, the one or more potential candidates identified by comparing characteristics for each candidate of the plurality of potential candidates to the obtained one or more items provided by the first client device, the method further includes: obtaining, by the server, a profile for each candidate of the plurality of potential candidates from a database, each candidate of the plurality of the potential candidates (i) having an associated client device and (ii) associated with the social networking application; for each candidate of the plurality of potential candidates: comparing, by the server, the one or more obtained items from the first client device to the characteristics in the profile of the candidate; in response to comparing, determining, by the server, a percent match between the one or more obtained items and the characteristics in the profile of each candidate; comparing, by the server, the percent match to a threshold value; and in response to determining the percent match for the candidate is greater than the threshold value, identifying, by the server, the candidate as a potential candidate.

In some implementations, wherein the data indicative of the potential candidates includes a first set of information describing the potential candidate, wherein the first set of information includes (i) a name of the potential candidate, (ii) a school of the potential candidate, (iii) a last known location of the potential candidate and the date the potential candidate was at that location, and (iv) other information pertaining to the potential candidate.

In some implementations, the method includes: in response to receiving the connection request to the one potential candidate from the first client device, identifying, by the server, the second client device associated with the one potential candidate by identifying the one potential candidate in the database and the second client device; and obtaining, by the server, the second set of information describing the first user, wherein the second set of information includes (i) a name of the first user, (ii) a photograph of the first user, (iii) biographical information of the first user.

In some implementations, wherein transmitting the first notification to the second client device associated with the one candidate further includes: transmitting, by the server, the first notification to the second client device, the second notification including (i) the indication that the first user associated with the first client device requests to open the communication channel between the first client device and the second client device, (ii) the second set of information describing the first user, and (iii) a second indication for the second user to either (i) decline the request for opening the communication channel or (ii) reveal additional profile information of the second user to the first user.

In some implementations, wherein receiving the second notification from the second client device indicating the one potential candidate request to reveal the third set of information with the first user further includes: identifying, by the server, the third set of information for the second user from the database, wherein the third set of information is different from the first set of information for the second user, wherein the server identifies the third set of information from a profile corresponding to the second user.

In some implementations, wherein receiving the request from the first client device to match with the second client device and open the communication channel further includes: receiving, by the server, the request from the first client device to match with the second client device, the request indicating that the first user recognizes the one potential candidate as a potential match for the different user from the prior encounter.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system in a social networking environment.

FIG. 2 is a flow diagram.

FIG. 3A is a block diagram that illustrates an example of a user interface for generating a profile.

FIG. 3B is another block diagram that illustrates an example of user interface for generating a profile.

FIG. 4A is a block diagram that illustrates an example of a user interface for interacting in the social networking environment.

FIGS. 4B-4E are diagrams that illustrate an example of a lost and found function.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

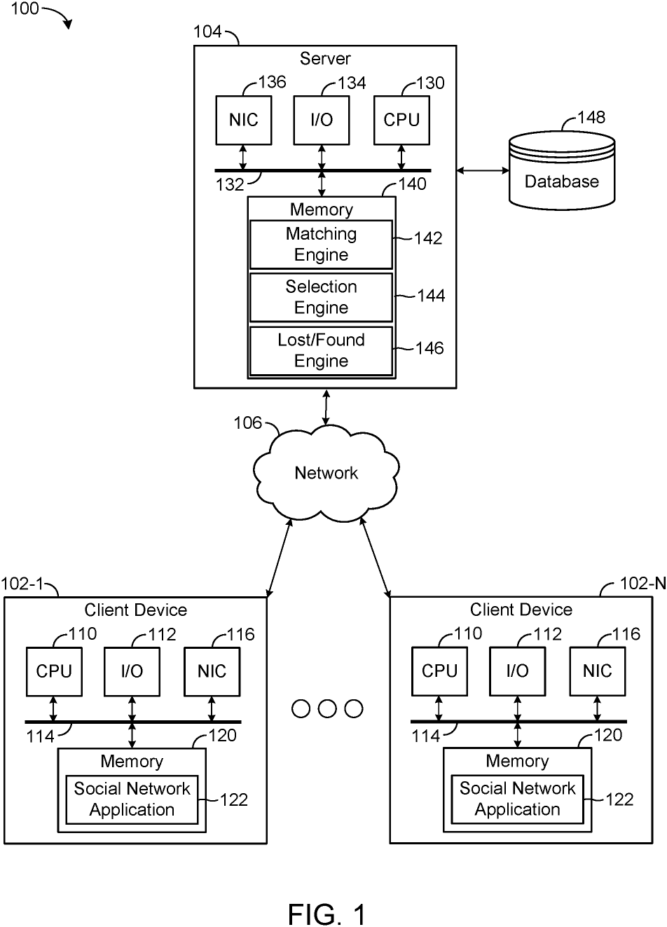

FIG. 1 is a block diagram that illustrates an example of a system in a social networking environment. In some implementations, the system 100 can include a plurality of client devices 102-1 through 102-N in communication with a server 104 via a network 106. The network 106 can include a wired, wireless network, or any combination thereof. For example, the network 106 can include a connection over the Internet, a Wi-Fi connection, a Bluetooth connection, or some other local or extranet connection.

Each of the client devices 102-1 through 102-N (hereinafter referred to as “client devices 102”) can include one or more processors, e.g., a central processing unit, 110 in communication with input/output devices 112 via a communication bus 114. The input/output devices 112 can include, for example, a touch display, a keyboard, a mouse, a combination of the above, or another means to interact with the client devices 102. The network interface circuit (NIC) 116 can connect to the communication bus 114 to provide wired and/or wireless connectivity to the network 106. A memory or other storage medium 120 is also connected to the communication bus 114. The memory 120 for each client device stores instructions executed by the processor 110. In particular, the memory 120 stores instructions for a social network application 122, such as a social dating application, which communicates with the server 104 for coordinating introductions between users that have been identified as potential matches, e.g., potential friends, dating partners, business partners, etc.

In some implementations, each client device 102 can be a mobile device. The client devices 102 can be, for example, a smart phone, a laptop, a tablet, a personal computer, a handheld device, a wearable device, or some other device. The client devices 102 can execute the social network application 122 stored in memory 120. Different users that subscribe to the same social network application can operate different client devices.

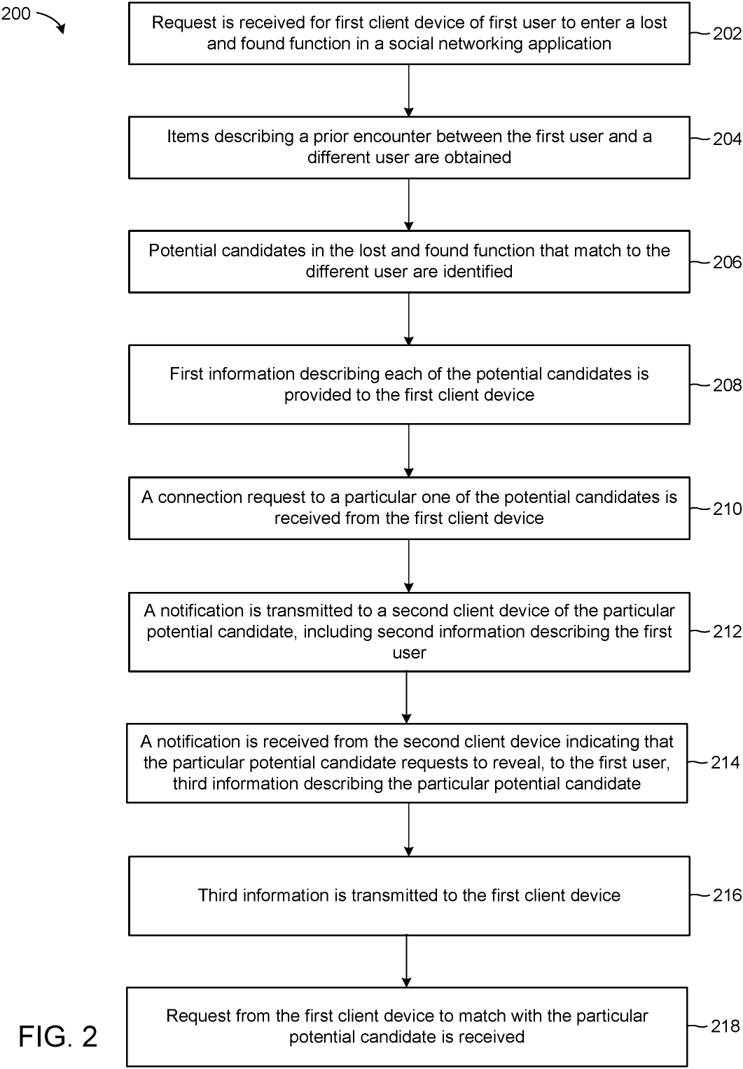

In some implementations, the server 104 can include one or more components for executing the social network application. For example, the server 104 can include one or more processors 130, a communication bus 132, input/output devices 134, a network interface card (NIC) 136, and memory 140, among other components. The memory 140 can connect to the communication bus 132. Additionally, the memory 140 can store a matching engine 142, a selection engine 144, and a lost/found engine 146. Each of the matching engine 142, the selection engine 144, and the lost/found engine 146 include instructions to be executed by the processor 130 to implement the processes and functions with respect to the disclosure and FIG. 2-4E discussed below.

In some implementations, the system 100 includes a database 148 in communication with the server 104. The database 148 can include, for example, one or more data storage components for storing information associated with the social network application 122. Additionally, the database 148 can store information associated with the matching engine 142, the selection engine 144, and the lost/found engine 146. For example, the database 148 can store information that describes each of the client devices 102, the user profiles associated with the client devices, historical matching information between user profiles, messaging information detailing messages between matched users, data detailing a lost/found function, and other information.

FIG. 2 is a flow diagram that illustrates an example of a process 200 for identifying a user in a lost and found function of a social networking environment. A request is received from a first client device associated with a first user (also sometimes called a requesting user) (202). he request is a request to enter a lost and found function in the social networking environment. Items describing a prior encounter between the first user and a different user are obtained (204). One or more potential candidates from among multiple potential candidates are identified that match to the different user (206) by comparing characteristics of each of the multiple potential candidates to the obtained items. A first set of information describing each of the identified potential candidates is provided to the first client device (208). A connection request to one of the identified potential candidates is received from the first client device (210). A first notification is transmitted to a second client device associated with the one of the identified potential candidates. The first notification indicates that the first user requests to open a communication channel with the second client device, and includes a second set of information describing the first user (212). A second notification is received from the second client device that indicates that the one of the identified potential candidates requests to reveal a third set of information to the first user, the third set of information describing the one potential candidates (214). The third notification including the third set of information is transmitted to the first client device (216). A request is received from the first client device to match with the second client device and open the communication channel (218).

This approach to progressive revealing of information can help to preserve user privacy and security while enabling the requesting user to find the person whom he or she is seeking. In some examples, as discussed below, the system can facilitate the searching by clustering potential candidates into categories by shared characteristics, and the requesting user can indicate to include or exclude entire clusters of potential candidates based on the characteristic of each cluster. This approach can help to narrow the set of potential candidates when there initially is a large number of potential matches.

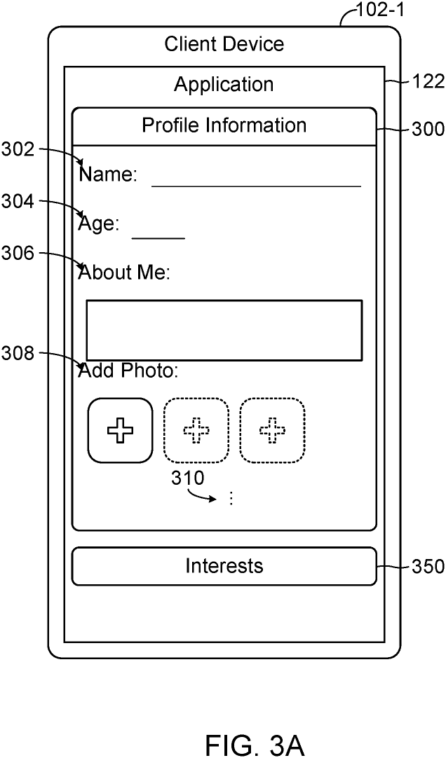

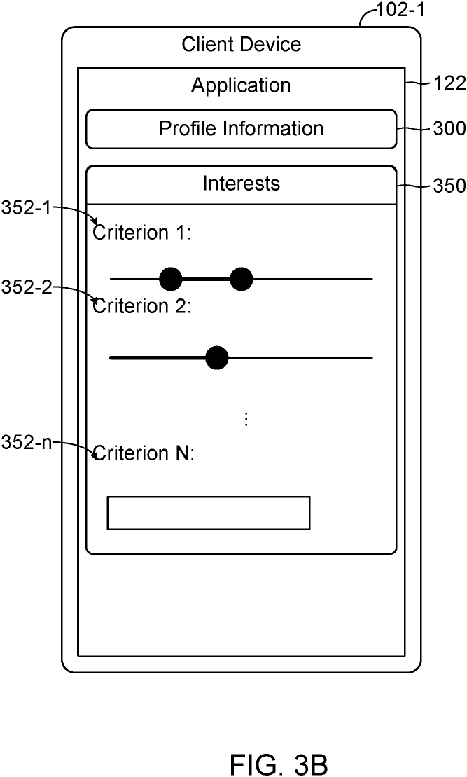

FIG. 3A is a block diagram that illustrates an example of a user interface 300 for generating a profile. The user interface 300 is presented to a user seeking to use the social networking application. Before interacting with others via the social networking application, the user can create a personal profile for participation in the social networking application. As illustrated on the user interface 300, the user can interact with the social networking application 122 of client device 102-1 to provide user profile information. The profile information can include, for example, the name 302 of the user, an age 304, biographical text 306, one or more photographs 308, and/or a variety of other fields 310. The other fields 310 can include, for example, city, links to social media profiles on other networks, religious beliefs, orientation, and other personal information about the user. Moreover, on the user interface 300, each user can specify their interests 350 by interacting with the button for the interests 350.

The user can provide his/her information for the personal profile by speaking into the client device 102-1, typing on a touch screen of the client device 102-1, or typing using a keyboard and mouse. In some implementations, the user can update his/her personal profile while using the social networking application. The personal profile can be updated and the changes can be reflected for other users to see at any time.

FIG. 3B is another block diagram that illustrates an example of user interface for generating a profile. FIG. 3B illustrates a different user interface of the social networking application 122 on the client device 102-1. For example, the client device 102-1 can illustrate a button for the user interface 300 from FIG. 3A and the user interface for the interests 350 showing the interests of the user. The user can transition from user interface 300 for the user profile to the user interface for the interests 350 by selecting the button for the interests 350 shown in FIG. 3A. Additionally, the user can transition from the user interface for interests 350 to the user interface 300 for the profile by selecting the button for the user interface 300 for the user profile information shown in FIG. 3B.

In some implementations, the user can specify their characteristics or criteria to help improve the matchmaking of the social networking application. For example, as shown in FIG. 3B, a user can specify their interests 350 by interacting with a user interface to provide various criteria 352-1 through 352-N that the user is looking for in a match. These criteria can include, for example, an age of a potential match, a distance the potential match is from the user, hobbies, commitment disposition, orientation, or a combination of the above factors.

In some implementations, the matching engine 142 of system 100 can identify one or more of the criteria 352-1 through 352-N instead of or in addition to those specified by the user based on, for example, analysis of the user’s interactions with the system 100. The system 100, and more specifically the matching engine 142, can use the interests 350 designated by each user profile to generate matching criteria for use in identifying potential matches for the user. Additionally, the matching engine 142 can take into account requests provided by the user for one or more potential matches.

Once a user profile has been completed, a user can begin to view the profiles of other users, while the user’s own profile is circulated among various other users in the social networking application. In some implementations, a user can receive a variety of profiles of other users who have been identified as potential matches based on their interests 350, e.g., identified criterion 352-1 through 352-N. The matching engine 142 can provide the variety of profiles of other users to the client device 102-1 of the user based on deriving matching criteria from the interests 350 to criteria from the interests of other users. Based on the matching criteria between users, the matching engine 142 can identify potential or recommended matches between users.

In response to the matching engine 142 identifying potential or recommended matches, the matching engine 142 can then provide the profiles of the potential matches to the user for review. Similarly, the matching engine 142 can perform the match identification and providing of profiles to other users, e.g., users of client devices 102-2 through 102-N in addition to the user of client device 102-1.

Generally, the matching engine 142 can determine one or more potential or recommended matches between users through a variety of processes. For example, the matching engine 142 can use filters, applied rules, trained machine learning algorithms, or some combination of these, among others, to identify potential or recommended matches for a particular user. For example, the matching engine 142 can generate one or more filters or rules based on the interests, e.g., interests 350, of a user, and can apply the filters or rules to users’ profile information for other users to identify a pool of applicants to provide as potential matches for the user. In another example, the matching engine 142 can include a machine-learning model, e.g., a neural network model, which has been trained to identify features from the profile and interests of a particular user. The machine-learning model can process profile information for other users to identify potential matches for the user. For example, the machine-learning model can receive criterion and interests of user A and criterion and interests of user B and output a likelihood of a match between user A and B. If the matching engine 142 determines the likelihood of a match, e.g., a percentage or statistic, is greater than the threshold value, then the matching engine 142 can provide the profile of user B to the client device of user A and provide the profile of user A to the client device of user B as a recommended or potential match.

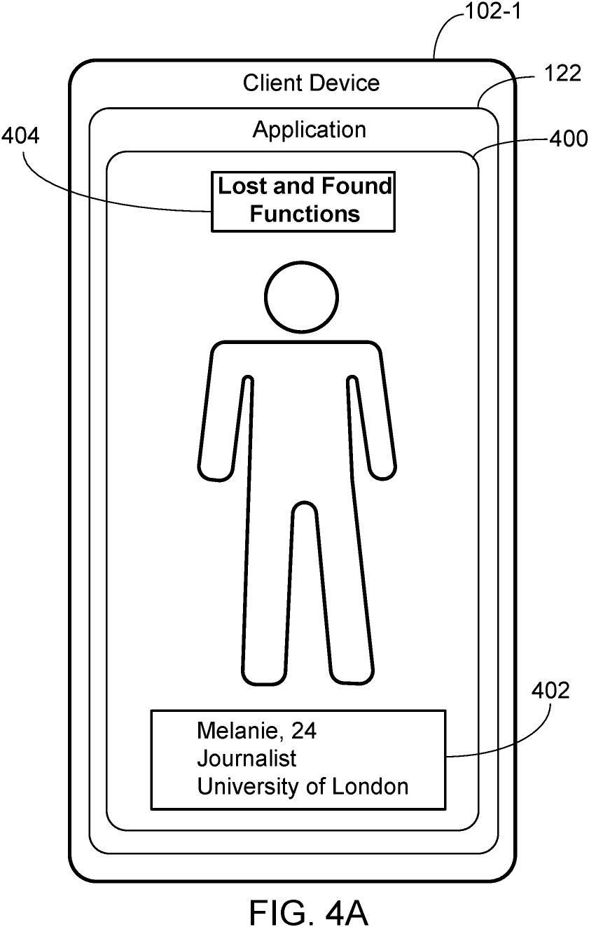

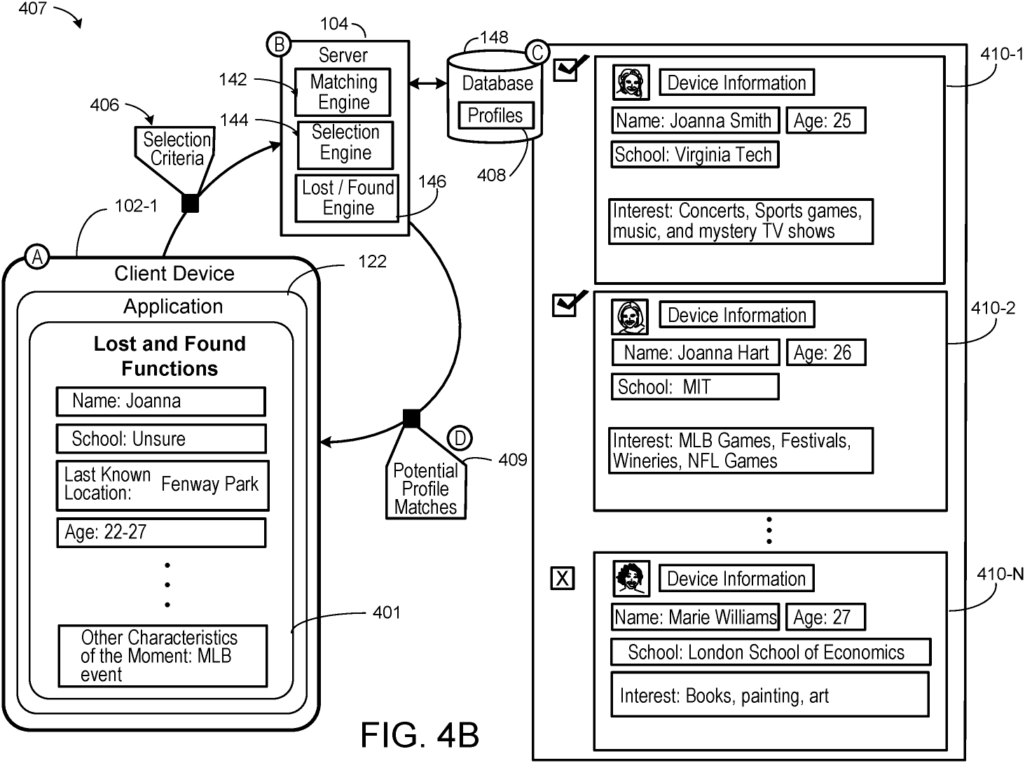

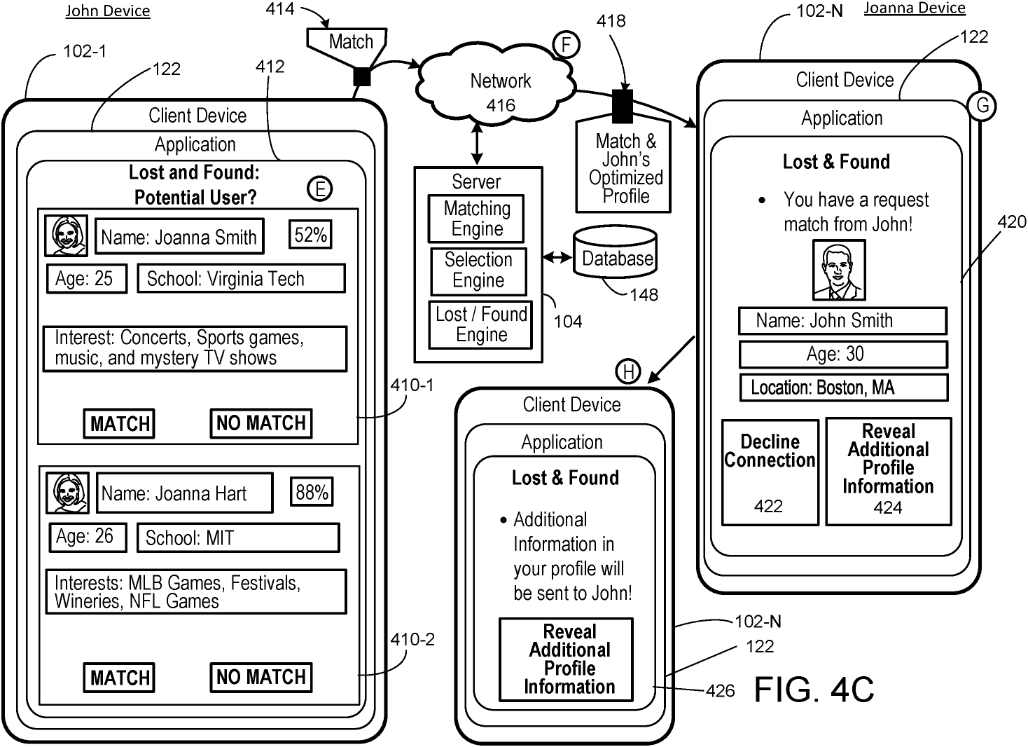

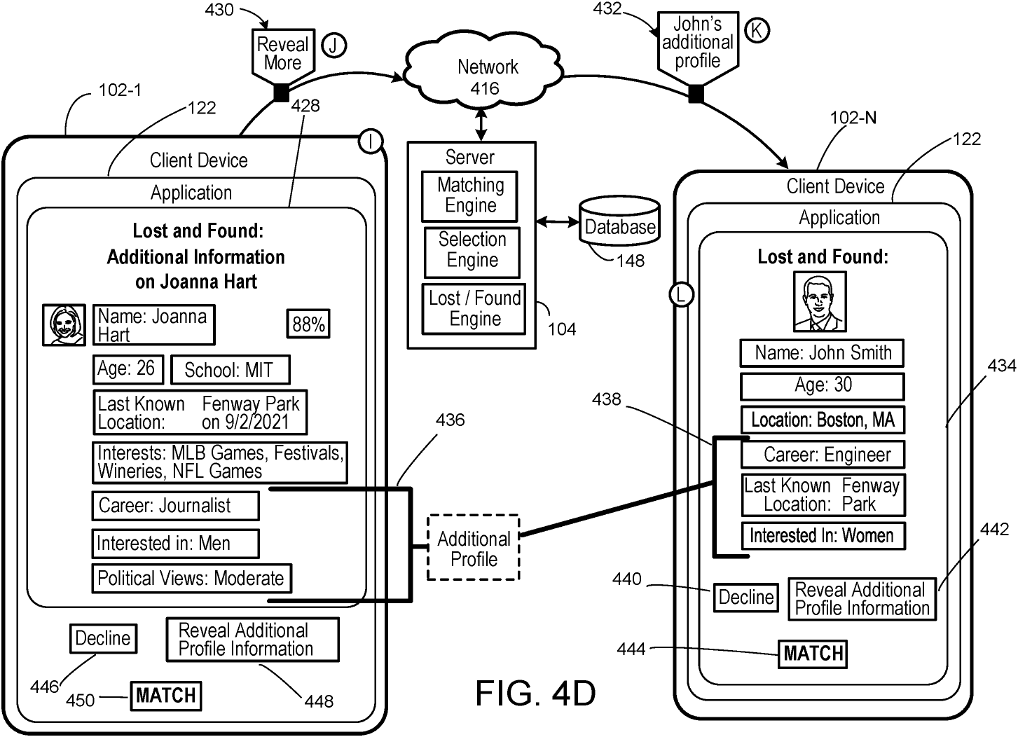

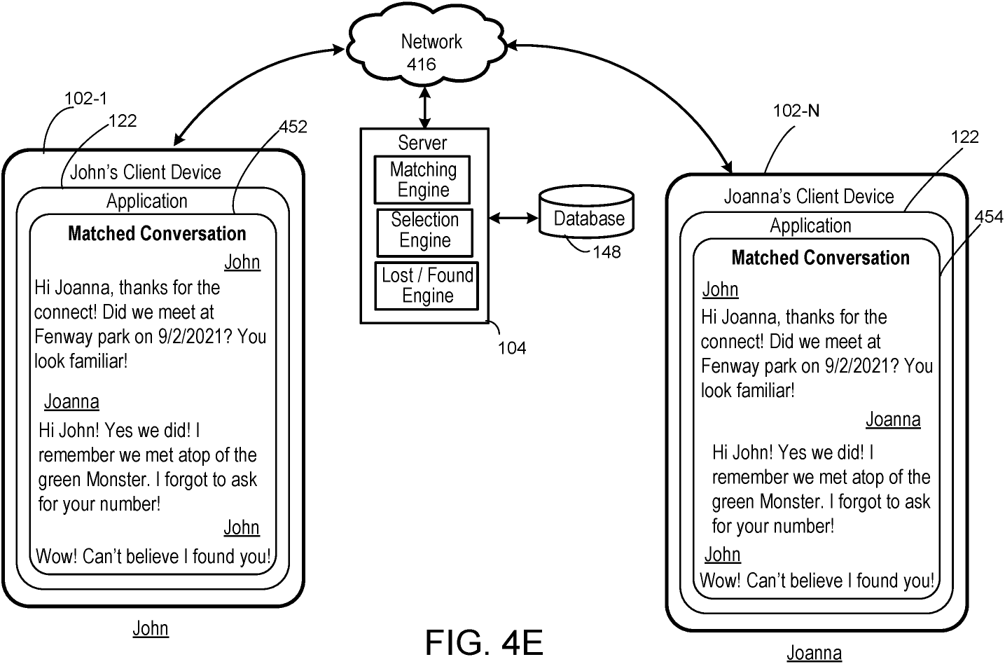

FIG. 4A is a block diagram that illustrates an example of a user interface 400 for interacting in the social networking environment. After the matching engine 142 has identified one or more potential matches for a user, the matching engine 142 can provide the profiles of the potential matches to the user for review. The user is then able to explore the provided match on his/her client device 102-1 in the social networking application 122. For example, as illustrated in FIG. 4A, the social networking application 122 executing on the client device 102-1 can display a user interface 400 that allows the user to view and explore the information that has been added to a potential match’s user profile. The user interface 400 can also include a prompt 402 that describes information about the user associated with the displayed user profile. The user interface 400 can also include a lost and found function 404, which will be further described below.

To ascertain a mutual agreement to connect two users together, each profile can be voted on by the viewing user. For example, after reviewing the personal profile of another user, the viewing user can vote “yes” indicating they would like to connect with that specific user, or vote “no” indicating they are not interested in connecting with that specific user.

In some implementations, the viewing user can vote “yes” by interacting with the display of the client device. For example, the user can click and drag the personal profile of another user by swiping the profile off the screen of the client device 102-1 in a particular direction, e.g., right, left, up, down, or other. In some implementations, the viewing user can vote “no” by interacting with the display of the client device. For example, the user can click and drag the personal profile of another user by swiping the profile off the screen of the client device 102-1 in an opposite direction from the particular direction to vote “yes.” If the user swipes right for a vote “yes” on the display, then the user can swipe left for a vote “no” on the display. In some implementations, if the user has voted “yes” for a profile of another user, the matching engine 142 can place the profile of the user into the queue of profiles to be viewed by the other user, e.g., the user voted as “yes.” Through this mechanism, the matching engine 142 is able to accelerate the pace with which two users view each other’s profiles than would typically occur in a purely organic system of profile selection.

When two users both mutually vote “yes” upon the viewing of the other user’s profile, a connection, e.g., a match, is established between the two users. Once a match is established, the matching engine 142 can supply a notification of the match to both of the matched users with a prompt to contact the other matched user. On the other hand, when one votes “yes” but the other user votes “no,” no further connection is established between the two users, and their profiles are not shown to each other again, e.g., or they may be shown again depending on changes with their profile, criterion, search parameters, or due to a time elapsing. In this manner, the matching engine 142 allows the intention of each user within the social network to be communicated.

In some implementations, the two matched users are directed to a messaging system of the social network to contact the other matched user. Once users are within the messaging system, a communication engine of the server 104 can manage the messages sent back and forth between the two users. In some implementations, the communication engine can display elements of user’s profile in order to increase recognition of the other user. The elements can include, for example, name, age, and photographs. Additionally, the communication engine can enable the matched users to speak in an auditory manner. In some implementations, the communication engine can convert the audio to one or more audible annotations to provide to both client devices.

In some implementations, the user interface 400 includes a lost and found function to enable the user of client device 102-1 to search for and identify the individual. The user can use the lost and found function to search for a prior acquaintance, an individual they previously met once and have not met since, or any other individual they so desire. However, the social networking applications maintains privacy of both individuals during the searching and identification of the lost and found function by progressively revealing users’ profile information in a consensual manner, as will be further described below.

In some implementations, the user interface 400 includes a lost and found function to enable the user of client device 102-1 to search and identify a group. The user can use the lost and found function to search for a prior group, a group that they were previously involved with, or any other group. These groups can be, for example, sporting groups, social media groups, themed groups, and other types of groups. In providing these features, the social networking applications can maintain privacy of the searching individual and the groups being searched during the searching and identification of the lost and found function by progressively revealing users’ and groups’ profile information in a consensual manner.

FIG. 4B is a block diagram that illustrates an example of a system 407 of a lost and found function. In some implementations, the user of client device 102-1 can select the lost and found function 404 from user interface 400 to search for and identify an individual. In response to interacting with the lost and found function 404, the user is displayed an interface 401. The interface 401 enables the user of client device 102-1 to provide one or more criteria for identifying an individual. The user can provide the criteria of the individual to be identified (referred to as “a lost acquaintance”) through the interface 401. FIG. 4B illustrates various operations in stages (A) though (D) which can be performed in the sequence indicated or another sequence.

In a particular example, John may have previously met a woman named Joanna at Fenway Park on Jan. 1, 2020. John only encountered Joanna one time and did not obtain any of her contact information to further communicate with Joanna, whether the reasons be for business needs or personal needs. John decides to search for Joanna through the social networking application 122 on his client device 102-1 to attempt to locate Joanna and reconnect with her.

During stage (A), the user, e.g., John, can enter criteria in the user interface 401 on his client device 102-1 that identifies the lost acquaintance. The criteria can include information about the prior meeting John remembers about Joanna. For example, the criteria can include information that characterizes Joanna and information about the event where they previously met. John can provide the criteria about Joanna through typing on his client device 102-1, speaking to his client device 102-1, or another form of input. In some implementations, the user interface 401 can enable the user, e.g., John, to provide various criteria about the lost acquaintance. The various criteria can include, for example, freestyle text, structured questions about the prior meeting with the lost acquaintance, unstructured questions about the prior meeting, and other information about the meeting between John and the lost acquaintance.

The user interface 401 may provide a template of fields for the user to provide criteria on the lost acquaintance. The template can include, for example, a name of the lost acquaintance, a school the lost acquaintance attended in high school, college, or other, a last known location of the lost acquaintance, an age of the lost acquaintance, and other characteristics of the lost acquaintance. Additionally, the template can include a customizable field for the user to provide any description relevant to the lost acquaintance that may be helpful for the server 104 to search for and identify the lost acquaintance. If the user is unsure of any of the template fields, then the user can leave those template fields blank or indicate that they are “unsure.”

As illustrated in system 407, John indicated that the user’s name is “Joanna,” he is “unsure” about the school Joanna attended, John’s last known location of Joanna is “Fenway Park,” Joanna’s age ranges somewhere between “22-27,” and John indicated characteristics about the moment in which they met, e.g., “MLB event.” As illustrated, the user searching for the lost acquaintance can provide not just a single identifier of the lost acquaintance, but an identifier that includes a broad range of values, e.g., Joanna’s age falls between ages 22-27, an astrology sign of Joanna, to improve the overall search functionality for the server 104.

In response to the user providing the criteria of the lost acquaintance to the user interface 401 of the client device 102-1, the client device 401 transmits the selection criteria 406 to the server 104 over a network. The client device 401 transmits the selection criteria 406 to the server 104 to perform the processing to attempt to search for and identify the lost acquaintance. In some implementations, the social networking application 122 on the client device 401 performs the processing to search for and identify the lost acquaintance.

During stage (B), the server 104 receives the selection criteria 406 from the client device 102-1. The server 104 can determine from the selection criteria 406 that the user associated with client device 102-1 seeks to identify an individual associated with the criteria defined in the received selection criteria 401. The server 104 can perform this process for one or multiple individuals that send the request. In particular, the matching engine 142 can identify the contents received with the selection criteria 406 to determine parameters for searching for the lost acquaintance.

The matching engine 142 can extract features from the selection criteria 406 to be used for searching for the lost acquaintance. For example, as illustrated in FIG. 4B, the matching engine 142 can extract the name, the school, a last known location, an age range, and characteristics about where the lost acquaintance and user of client device 102-1 met. Additionally, the selection criteria 406 may include other criteria that the matching engine 142 can extract. For example, the other criteria can include activities about the lost acquaintance, such as activities they are interested in, likes and dislikes, pictures of the lost acquaintance, their home address, their work address, their personal and/or work email address, astrology information of the user, and other information. The matching engine 142 can extract this information from the selection criteria to build a search query for identifying the lost acquaintance.

In some implementations, the matching engine 142 can extrapolate and/or interpret information about the lost acquaintance using the extracted data from the selection criteria 406. For example, if the selection criterion 406 includes characteristics about where the two users met, then the matching engine 142 may interpolate or extrapolate their meeting place as a means to identify one or more interests of the lost acquaintance. For example, if the two users met at a MLB game, then the matching engine 142 may extrapolate that the lost acquaintance has an interest in sports, and more particularly, baseball. Additionally, if the two users met at a concert, then the matching engine 142 may extrapolate that the lost acquaintance likes music and the artist or band performing at the concert may be one of the lost acquaintance’s preferred artist or band. In another example, if the selection criteria 406 indicates that the two users met overseas in Italy and that the lost acquaintance is from America, the matching engine 142 may extrapolate that the lost acquaintance (i) is from America, (ii) likes to travel, and (iii) may have family or friends who live in Italy. The matching engine 142 can extrapolate the data provided in the selection criteria to identify interests and/or characteristics of the lost acquaintance.

In response to extracting and extrapolating information from the selection criteria 406, the matching engine 142 generates a query to poll the database 148 for profiles that match to characteristics identified and extrapolated from the selection criteria 406. For example, the matching engine 142 can generate a query that includes an itemized list of the data identified from the selection criteria 406. To expand the overall results of the query, the matching engine 142 can build a query that characterizes items to be matched in an “OR” fashion. In this case, a profile in the database 148 only need to match to one or more of the items in the query and not all of the items. Generally, the matching engine 142 can determine a statistical likelihood of the user profile matching to the lost acquaintance depending on an amount of factors or items that match to the items included within the transmitted query.

In some implementations, the matching engine 142 can use the query to match to similar astrology information stored in the profiles of the database 148. In some examples, the matching engine 142 can use the query to match to astrology information that are determined to be good matches. For example, if the query includes an astrology sign of the searching user, e.g., “aries”, then the matching engine 142 can seek profiles that include astrology signs that are determined to be compatible with “aries”, such as “sagittarius”, “gemini”, and “libra”, to name some examples. Similarly, if the query includes an astrology sign of “taurus” of the searching user, then the matching engine 142 can seek profiles that include astrology signs that are determined to be compatible with “taurus”, such “capricorn”, “virgo”, and “cancer”. Other examples are also possible. The matching engine 142 can search for profiles of users that have astrology signs compatible with the astrology sign in the query because these types of compatibilities may be communicated between users during their prior meeting or encounter. For example, John may not remember that the person he met was named “Joanna” or her astrological sign, but John may remember that the person he met had a compatible astrological sign with “taurus”. Consequentially, the matching engine 142 can search for profiles that have compatible astrological signs to John’s “taurus”.

During stage (C), the server 104 identifies users in the profiles 408 section of the database 148. Specifically, the matching engine 142 identifies users in the database 148 that match to the data identified in the query based on a statistical likelihood. For example, as illustrated in system 407, the database 148 includes various user profiles, e.g., 410-1 through 410-N. The user profile 410-1 is a profile for Joanna Smith. The user profile 410-2 is a profile for Joanna Hart. The user profile 410-N is a profile for Marie Williams.

In some implementations, the information in a profile can be categorized into multiple categories, or buckets. The profiles 408 within the database 148 can be associated with the one or more buckets. Each bucket is associated with different security characteristics for the information of the profile. Information in a first bucket can be for a limited set of profile information that can be visible to all users of the social network, e.g., first name, first letter of last name, age, or other generic information. A second bucket can be for information that is slightly more revealing than the limited information in the first bucket. For instance, information in the second bucket can include the user’s university, state of residence, or other somewhat identifying information. A third bucket can be for personal information, e.g., medical information, identifying characteristics (e.g., tattoos), or other personal information. Other numbers of buckets are also possible. Each user can designate which information in his or her profile is to be associated with each of the buckets.

When a profile of a potential acquaintance is identified as a potential match to a requesting user, as discussed in more detail below, only the limited information in the first bucket is revealed initially to the requesting user. If the requesting user believes the match is correct, the potential acquaintance is notified and offered the opportunity to reveal additional information from the second bucket, e.g., some or all of the information from the second bucket. Subsequent interactions can result in the potential acquaintance being offered the opportunity to reveal personal information from the third bucket. This progressive reveal ensures user privacy and security while still enabling users to determine whether they are the sought-after match.

In some implementations, the database 148 can build profiles 408 for a variety of users that use the social networking application. When a user signs up to use the social networking application through their respective client device, the server 104 receives the user’s information and builds a profile to be stored on the database 148. The server 104 may update a profile over time based on the user’s activities, e.g., criteria changing, last known location, a change in interests, and other profile information.

In some implementations, the database 148 can also build profiles 408 for a variety of users that do not use the social networking application. These users not using the social networking application can include (i) friends/business contacts/partners of the users who do use the social networking application, (ii) recommended users who would benefit from using the application, as well as (iii) referrals of people who should use the application from users who do use the social networking application. The database 148 can include their name, contact information, as well as other data describing or identifying these users in profiles 408.

The server 104 may access a client device of a member of a social networking application and add individuals on the member’s contact list to the profiles 408 as friends/business contacts/partners of these members. Additionally, the server 104 may access other social networking applications of the member and retrieve their friends or contact list to add to the profiles 408 in the database 148. The server 104 can determine recommended users who would benefit from using the application by identifying contacts on member’s client device contact lists and identifying those contacts that are the most active on other social networking applications. The server 104 can determine user activity by determining how often they log in and interact with the other social networking application. In other cases, the server 104 may access the other social networking applications to identify users who are seeking contacts with other individuals. These users may be recommended users to include as users for the social networking application of system 407. Additionally, the server 104 can send a request to the client device 102-1 to ask for referrals of individuals who should use this social networking application of system 407. The server 104 can store the responses to the request from client device 102-1 as contacts within the profiles 408.

In some implementations, the server 104 can also use the selection criteria 406 provided by the client device 102-1 to search other platforms for users to add to the database 148. For example, the server 104 can search the Internet, other social networking applications, and other client devices to identify individuals to include in the database 148. These individuals can then by identified by the server 104 when trying to identify a lost acquaintance, such as the individual seeking to be identified in system 407.

As illustrated in system 407, the database 148 includes a profile 410-1, a profile 410-2, and a profile 410-N. The profile 410-1 illustrates device information for the user, a name of the user, e.g., Joanna Smith, an age of the user, e.g., 25, a school attended, e.g., Virginia Tech, and interests of the user, e.g., concerts, sports games, music, and mystery TV shows. Other examples are also possible. Profile 410-2 illustrates device information for Joanna Hart, the name Joanna Hart for the user, age 26 of Joanna Hart, MIT as the school attended, and interests in MLB Games, Festivals, Wineries, and NFL games. Profile 410-N illustrates device information for Marie Williams, the name Marie Williams for the user, age 27 of Marie Williams, London School of Economics for the school attended, and interests in books, painting, and art. Additionally, the profile for each user can include last known locations of the user, e.g., using GPS coordinates of the user’s client device or other location data. The GPS coordinates can be updated and stored in the database 148 on a periodic basis. The server 104 can seek to match data from the provided query to each of the data included in the profiles.

In some implementations, the server 104 can match the data elements in the query to data elements in each user profile. Specifically, the matching engine 142 can perform techniques for matching the data elements in the query to data elements in each user profile. These techniques can include, case sensitivity, case insensitivity, string matching, partial string matching, reverse matching, Boolean matching, and other matching operations, to name a few examples. The matching engine 142 can identify a user profile to be returned to the client device 102-1 based on a matched number of items greater than a threshold value, for example. If more than 25% of the items in the user profile match to the data in the search query, then the matching engine 142 can return those respective items to the client device 102-1 for the corresponding user’s review. As illustrative in system 407, the matching engine has identified profile 410-1 and user profile 410-2 as profiles that match to the query greater than a threshold value, as indicated by the checkmarks next to their user profile boxes. However, profile 410-N did not match to the items included within the query, and may not be returned to the client device 102-1. As such, the “X” mark next to the user profile box 410-N indicates a profile that was not selected to be included in the results.

During stage (D), the matching engine 142 generates a data package 409 with potential profile matches to be returned to the client device 102-1. The data package 409 can include, for example, the data from each of the selected profiles, a link to access the profile information in the database 148, and other data describing the selected profiles. The matching engine 142 can retrieve the profiles, build the data package 409, and transmit the data package 409 to the client device 102-1 over the network 416 to be displayed on the client device 102-1.

In some implementations, the matching engine 142 generates a data package 409 that includes optimized profile matches of users. The optimized profile matches of users may include a subset of information about the corresponding user and not a totality of information about the user stored by the server 104. The subset of information may include, for example, an image of the user, a name of the user, an age of the user, a last known GPS location of the user. The server 104 identifies only a subset of the information to provide in the data package 409 to preserve the security of each user associated with the potential profile matches.

FIG. 4C is another block diagram that illustrates an example of various user interfaces of a lost and found function. The processes illustrated and described with respect to FIG. 4C are a continuation of the processes illustrated and described with respect to FIG. 4B. In particular, the processes of FIG. 4C illustrate the processes performed after the server 104 provides potential matched candidates to the client device 102-1 from stage (D) of FIG. 4B. FIG. 4C illustrates various operations in stages (E) though (H) which can be performed in the sequence indicated or another sequence.

During stage (E), the client device 102-1 has received the potential profile matches from the server 104 and displays the potential profile matches for John to review. The client device 102-1 displays user profile 410-1 and user profile 410-2 for John to review. Additionally, when then matching engine 142 provides the potential profile for client device 102-1, the matching engine 142 can also determine and provide a statistical value for the match. The statistical value can be identified by (i) a number of matches between items in the query and items in the user profile, (ii) a number of non-matches between items in the query and items in the user profile, and (iii) a set percentage match required by the matching engine 142. For example, the matching engine 142 indicates that Joanna Hart’s profile has a match of 52% and Joanna Jones’s profile has a match 88% to the items identified by John during stage (A) of FIG. 4B. The statistical percentage can aid John in identifying matches that more closely identify to the potential match.

In some implementations, the server 104 may provide the potential profile matches to the client device 102 if the number of potential profile matches is less than a threshold amount. For example, the server 104 may provide the potential profile matches to the client device 102 if the number of potential profile matches is less than 10. The implementer of the system can set other threshold values. Alternatively, if the number of potential profile matches is greater than a threshold value, then the server 104 can initiate a reduction process.

The server 104 can perform a reduction process to aid the user associated with the client device 102 in identifying potential profile matches. Specifically, the server 104 may segment and group the profile matches using clusters. The profiles may be grouped into clusters using characteristics of each profile. For example, the server 104 may group one set of profile matches that are located in Washington D.C., another group of profile matches that include black hair, another group of profile matches that like country music, and so on. The server 104 may segment and group the clusters on a variety of topics. Then, the server 104 may instead provide the data that groups each cluster to the client device 102-1. In this case, the server 104 can provide to the client device 102-1 data identifying or characterizing each of the clusters, and the user associated with client device 102-1 can select one or more clusters that the user believes may include the potential lost acquaintance. For example, the server 104 may perform a reduction process on the potential matches and identify a cluster of profiles—one cluster including profiles of users having brown hair, another cluster including profiles of users having blonde hair, and another cluster including profiles of users having red hair. The server 104 can provide each of these clusters to the client device 102-1 and the user may indicate that the potential lost acquaintance had red hair, which ultimately reduces the amount of potential profile matches to those in the cluster having red hair. In some examples, the requesting user can identify clusters to eliminate rather than clusters to include.

Then, the server 104 may compare the number of profile matches in the user-selected cluster (e.g., the profiles of users having red hair) to the threshold value. If the number of profile matches in the user-selected is less than the threshold value, then the server 104 can transmit those potential profile matches to the client device 102-1 for the associated user’s review. Alternatively, the server 104 may perform a second reduction process on the potential profile matches in the cluster of profiles having red hair. This may be an N-step reduction process until the number of profiles is less than the threshold value. For each reduction process, the server 104 may identify another topic to group these profiles, such as their location, for example. Other examples for segmenting and grouping the potential profiles are also possible.

In some implementations, the server 104 may utilize one or more trained machine-learning models to perform the clustering. The server 104 can train the machine-learning models to cluster profile matches based on commonalities. In some cases, these commonalities may be topics or criteria identified by the user as the lost acquaintance potentially exhibiting. In other cases, the trained machine-learning models may identify commonalities of potential profile matches unbeknownst to the user associated with client device 102-1.

In some cases, the user associated with client device 102-1 may select one or more clusters during the server 104′s reduction process. For example, the clusters may indicate a group of profiles representative of users that have brown hair, a group of profiles representative of users that live in New York City, and another group of profiles representative of users that had above a 3.5 GPA in university, to name a few examples. Other examples are also possible. The user associated with client device 102-1 may remember that the lost acquaintance lived in New York City, had brown hair, but did not attend university. In this example, the user associated with client device 102-1 can select the first cluster and the second cluster and not select the third cluster. By narrowing down the criteria of the potential profile matches, the server 104 can aid the user in identifying the lost acquaintance by (i) identifying clusters that manifest themselves in the results and (ii) identify clusters with the aid of the user’s selection in order to eliminate the most likely profiles and ultimately, reduce the amount of profiles to search through.

In some implementations, the client device 102-1 can indicate which items of a user profile match to the items identified by John to identify the lost acquaintance. For example, the client device 102-1 can bolden, highlight, or otherwise emphasize the words in the provided user profiles that match to the items that John provided. In the example of FIG. 4C, the client device 102-1 can, for user profile 410-1, bolden the words “Joanna,” age “25,” and “Sports games.” For user profile 410-2, client device 102-1 can bolden the words “Joanna,” age “26,” last known location “Fenway Park,” and “MLB games.” In this manner, John can quickly identify his terms provided and where those terms match in a potential profile.

In some implementations, the profiles provided by the server 104 to the client device 102-1 may be anonymous. The anonymous profiles may reveal information about the user profile without identifying the names of the users associated with those profiles. In this manner, the potential lost acquaintances can have their identities protected in a secure manner. Only at a later reveal is their identity revealed to the requesting user.

In some implementations, after reviewing the potential user profile matches, the user associated with client device 102-1, can select a potential lost acquaintance. John, the user associated with client device 102-1, can select a user that he thinks is the lost acquaintance based on the matching characteristics identified by the server 104. As illustrated in FIG. 4C, John can select from one or more potential matches and select either “MATCH” or “NO MATCH.” For example, John can select “NO MATCH” for user profile 410-1 and “MATCH” for user profile 410-2. In another example, John can select “NO MATCH” for both user profiles or “MATCH” for both user profiles.

In response to selecting “MATCH” to user profile 410-2, the client device 102 transmits the selected match 414 over network 416 to the server 104. The server’s lost/found engine 146 can identify the contact information for the user identified by the user profile 410-2 included in the match 414 and transmit a request 418 by way of the user’s contact information. The contact information can include, for example, an address of the client device for the user identified in user profile 410-2, an application ID for the user identified in user profile 410-2, an email address of the user in user profile 410-2, or some other manner to contact the user identified in the user profile 410-2. Then, the lost/found engine 146 can generate a request to transmit to the potential lost acquaintance.

The request can include data identifying the user John, and data identifying the user Joanna Jones. For example, the lost/found engine 146 can access John’s profile information from the database 148 and include a subset of his profile information in the request. The lost/found engine 146 can select the subset of his profile information to preserve John’s privacy while ensuring Joanna views a sufficient amount of information to identify John. For example, the subset of John’s profile information can include a user profile image of John, his full name, his age, and his current location, last known location, or location where John has indicated he met Joanna during stage (A) of FIG. 4B. Additionally, the lost/found engine 146 can include graphical user interface (GUI) buttons to enable Joanna to decline the connection request or to reveal additional profile information of Joanna. The lost/found engine 146 can build the request 418 to send to the client device 102-N associated with Joanna.

During stage (F), the lost/found engine 146 transmits the request 418 to the client device 102-N associated with Joanna over network 416. The request 418 includes a request to connect, John’s optimized profile information, and an ability to decline the connection request from John. In some implementations, the lost/found engine 146 can store the request 418 on the database 148 and transmit a link to the client device 102-N for Joanna to access. By storing the request 418 on the database 148 and transmitting only a link to the request 418, the server 104 can ensure that the database 148 tracks each of the requested profile matches identified between client devices. Additionally, the server 104 can reduce bandwidth consumption between client devices by only sending a link between potential matching users, e.g., their client devices, and not sending the data package that includes their profile information.

During stage (G), the client device 102-N receives the request 418 from the server 104. The client device 102-N extracts the data from the requests 418 and displays the extracted data for Joanna to review. In some implementations, if the recipient user has access to the social networking application via their client device 102-N, then the client device 102-N can notify the owner that a notification has been received through the social networking application. In other implementations, if the recipient does not have access to the social networking application via their client device 102-N, then the recipient may be notified by email or text-message of a connection request for a potential application. In this implementation, the recipient can decide to download the social networking application on their client device or access the notification via an online-version of the social networking application without downloading the social networking application.

The client device 102-N can display a GUI 420 of the information extracted from the request 418. The GUI 420 can illustrate and/or describe that a user has requested to connect through a lost and found application of the social networking application. The GUI 420 can display, for example, optimized information that includes a photo of the user requesting to connect, a name of the user, an age of the user, and a current location of the user, a last known location of the user, or a location where requestor has indicated he met the recipient. In some examples, the GUI 420 can display a live stream video of one of the users or a video chat between the two users.

Additionally, the GUI 420 can display GUI buttons 422 and 424. The GUI button 422 can be a decline connection button. The GUI button 424 can include a reveal additional profile information. The user associated with client device 122-N, e.g., Joanna Hart, can take multiple options upon receiving this request 418 from the requestor’s client device 102-1. For example, Joanna can determine from the request that the requestor appears to desire to connect with and has subsequently searched for her information through the server 104. Additionally, Joanna may recall a time when she previously met with John Smith. However, in some cases, Joanna may not remember ever having met John. In either case, Joanna can decide to decline the connection request by interacting with GUI button 422 or reveal additional profile information of herself by interacting with GUI button 424. If she interacts with GUI button 422, then the GUI 420 on her client device 102-N will close and the server 104 may or may not notify client device 102-1 that the user associated with client device 102-N has declined the request to connect.

In some implementations, the GUI 420 can also display a request to enhance the security of the match. Before the user associated with client device 102-N can reveal additional information, the GUI 420 on client device 102-N can display a GUI text that requests user of client device 102-N to answer whether they were located at a particular location on a particular date. For example, the GUI 420 may display a GUI that requests Joanna to answer the question of “Were you located at Fenway Park on Jan. 1, 2020?” The question posted to the user of client device 102-N can include a date and location that represents where user of client device 102-1, e.g., John, met the lost acquaintance. If Joanna answers “Yes” to the posed question, then the server 104 can indicate to John the increase likelihood that Joanna is the lost acquaintance. In some implementations, the client device 102-N can provide the response to the additional security question to the server 104. In some cases, if the user associated with the client device 102-N answers “No,” then the server 104 can cancel the connection or notify the user associated with client device 102-1 that the connection should be canceled based on the user 102-N’s indication that she is most likely not the lost acquaintance. The server 104′s provisioning of the question can also happen at a later stage during the progressive reveal of information.

During stage (H), the user associated with client device 102-N has decided to reveal additional profile information by interacting with GUI 424. In some implementations, the server 104 seeks to maintain privacy between the requesting user and the recipient. Thus, the server 104 ensures that a particular user cannot just search for a recipient and automatically initiate a matched conversation with the recipient, but the recipient and requesting user must both consent to communicating with one another before a matched conversation is initiated. The manner in which the server 104 ensures the privacy information of both users is to reveal profile information of each user to the other user in a progressive and consenting manner.

In this manner, when the user associated with client device 102-N requests to reveal additional profile information GUI button 424, the server 104 transmits additional profile information that describes a user of client device 102-N to the client device 102-1. The additional profile information can aid the user associated with client device 102-1 that the potential matched user is in fact or is not in fact the lost acquaintance. In response to selecting the reveal additional profile information GUI button 424, the client device 102-1 transitions the user interface of their client device from user interface 420 to user interface 426. The user interface 426 indicates to the user associated with client device 102-N, e.g., Joanna, that the server 104 can send additional profile information describing Joanna to the requesting user, e.g., John Smith.

FIG. 4D is another block diagram that illustrates an example of various user interfaces of a lost and found function. The processes illustrated and described with respect to FIG. 4D are a continuation of the processes illustrated and described with respect to FIGS. 4B and 4C. In particular, the processes of FIG. 4D illustrate the processes performed after the server 104 receives a request to reveal additional profile information of the user associated with client device 102-N from stage (H) of FIG. 4C. FIG. 4D illustrates various operations in stages (I) though (L) which can be performed in the sequence indicated or another sequence.

During stage (I), the server 104 can receive the request from the client device 102-N to reveal additional profile information of the user associated with the client device 102-N in response to the user selecting the reveal additional profile information GUI button 424. The server 104 can identify additional profile information for the selected user. For example, the lost/found engine 146 can identify the profile of the potential user profile of the user associated with client device 102-N and identify a few more items of profile information to provide to client device 102-1. The additional profile information may include more items but not the remaining items identified in the user profile of the user associated with client device 102-1. For example, the lost/found engine 146 can identify two or three items not previously identified, such as during stage (D) of FIG. 4B, when five items remain in the user profile that have not yet been revealed. Other examples are also possible.

For example, the server 104 can identify additional profile information 436 that includes a career of Joanna, her interested in, and her political views. Joanna’s career is a journalist, she is interested in men, and her political views are moderate. In this example, John can review the additional profile information 436 provided by the server 104 and interpret that (i) Joanna has decided to reveal additional profile information about herself to John and (ii) the server 104 had additional profile information to reveal on Joanna. John can decide a few actions to take at this point. If John decides after reviewing the additional profile information 436 of Joanna that Joanna is not the lost acquaintance that John was searching for, John can decline the connection request by interacting with the decline GUI button 446 on client device 102-1. Alternatively, if John believes completely that Joanna is the lost acquaintance, then John can select the match GUI button 450 to request a match to communicate with Joanna in a private chat. Additionally, if John believes that Joanna is the lost acquaintance but is not completely convinced, John can select the reveal additional profile information GUI button 448.

During stage (J), John selects the reveal additional profile information GUI button 448 on the interface 428 of his client device 102-1. The client device 102-1 generates a request 430 that indicates to the server 104 that John desires to reveal more information about himself. Then, the client device 102-1 transmits the request 430. The request 430 can include text or a notification indicating to the server 104 to provide more information about John to Joanna. The client device 102-1 can transmit the request 430 to the server 104 over network 416.

The server 104 can receive the request 430 and determine that the user associated with client device 102-1 decides to reveal more information about himself or herself to the recipient. Specifically, the lost/found engine 146 can access John’s profile information from the database 148 and retrieve additional profile information about John to provide to client device 102-N, the additional profile information including information not previously retrieved about John during stage (G) of FIG. 4C. The lost/found engine 146 can retrieve the additional profile information about John from the database 148, e.g., additional profile information 438. For example, the additional profile information 438 can include career information, religious interests, political interests, interested in information, last known location, movie interests, and other information characterizing the user associated with client device 102-1. The lost/found engine 146 can build a data package 432 that includes the additional profile information 438 to provide to client device 102-N. The data package 432 can also include GUI buttons that enable Joanna to decline the connection request, reveal additional profile information of Joanna, and match to John. The lost/found engine 146 can build the data package 432 and transmit the data package 432 to client device 102-N over network 416 for Joanna to review.

During stage (K), the lost/found engine 146 can transmit the data package 432 to client device 102-N over network 416. In some implementations, the lost/found engine 146 can store the data package 432 on the database 148 and transmit a link to the client device 102-N for Joanna to access the data package 432. Stage (K) is similar to stage (F) from FIG. 4C.

During stage (L), the client device 102-N receives the data package 432 from the server 104. Stage (L) is similar to stage (G) from FIG. 4C. In particular, the client device 102-N extracts the data from the data package 432 and displays the extracted data for Joanna to review. For example, the client device 102-N can display a GUI 434 of the information extracted from the data package 432. The GUI 434 can include similar information as illustrated in GUI 420 but with the addition of the additional profile information 438. The additional profile information 438, as illustrated in FIG. 4D, can include John’s career as an engineer, John’s last known location of Fenway Park, and an indication that John is interested in women. Additionally, the GUI 434 can include GUI buttons 440, 442, and 444.

The GUI button 440 is the decline button. If Joanna determines after reviewing the additional profile information 438 of John that Joanna does not know or does not want to connect with John, then Joanna can decline the potential connection John. The GUI button 442 is the reveal additional profile information button. If Joanna decides she wants to reveal more profile information about herself to John, then Joanna can select the reveal additional profile information GUI button 442. In this case, in response to selecting the GUI button 442, the client device 102-N can transmit the request to server 104. The server 104 can receive the request and provide additional profile information about Joanna for John to review. The GUI button 444 is the match button. If Joanna decides to match with John, then Joanna can interact with the match GUI button 444. In response to selecting the match GUI button 444, the client device 102-N can transmit the request to the server 104. The server 104 can receive the request sent by Joanna to connect with John and transmit a request to John indicating that Joanna has requested to match. John can then decide to accept the connection request or decline the connection request.

In some implementations, the two users can continue to reveal additional profile information between one another until a condition has been met. For example, the two users can continue to reveal additional profile information to the other until they (i) decide to match, (ii) exhaust the items to reveal from their profile, or (iii) decide to cancel the connection. By providing additional profile information in a progressive manner

In the example in which they decide to match, at any point in time during the revealing of additional profile information between the two users, one of the users may transmit a match to the other. The match may signify either that one user recognizes the other, sufficient profile information has been revealed, and/or the requesting user desires to communicate with the other user. For example, John can select the match GUI button 450 on his respective client device 102-1, and the server 104 in response to receiving the match request transmits a request to the client device 102-N, where Joanna has to select the match button 444 for a communication line to open. Either party can decline the match request connection.

In the example in which they have exhausted the items to reveal from their respective profile, the server 104 may transmit a notification to a particular user when that user’s profile information has been exhausted. For example, John may request to reveal additional profile information by interacting with the GUI button 448 after reviewing additional profile information 436 about Joanna. In response to selecting the reveal additional profile information GUI button 448, the client device 102-1 can transmit a notification to the server 104 requesting additional profile information about John be sent to client device 102-N. However, the lost/found engine 146 can identify John’s profile in the database 146 and determine that all of John’s profile information has been revealed to Joanna. In response, the lost/found engine 104 can transmit a notification to John’s client device 102-1 indicating that all profile information has been revealed to Joanna and the remaining options to communicate are to (i) send a match or (ii) send a decline. John can select an option for either pursuing or not pursuing this connection request.

In the example in which they one of the user’s decides to cancel the connection, the communication ceases between the two users. In particular, the server 104 can send a notification to the other user indicating the other user’s wish to decline the conversation. At this point, the two users can continue communicating with other connections.

FIG. 4E is another block diagram that illustrates an example of various user interfaces of a lost and found function. The system illustrated in FIG. 4E shows user interfaces for client devices 102-1 and 102-N in response to the two users, e.g., John and Joanna, consenting to match and communicate with one another. FIG. 4E can be a continuation of the processes illustrated and described with respect to FIGS. 4A through 4D. In particular, John or Joanna may decide to initiate a matched connection by interacting with match GUI button 450 or match GUI button 444, respectively. In response, the receiving user can accept the request to match and transition to user interfaces for communicating in a chat on their respective client devices.

In some implementations, the two users’ respective client devices transition their interfaces to the chatroom interface. For example, client device 102-1 displays user interface 452 and client device 102-N displays user interface 454. Both John and Joanna can communicate with one another within the chatroom. As illustrated in the example of FIG. 4E, John can initiate the conversation stating “Hi Joanna, thanks for the connect! Did we meet at Fenway park on Sep. 2, 2021? You look familiar!” In response, Joanna responds with “Hi John! Yes we did! I remember we met atop of the green Monster. I forgot to ask for your number!” John can respond with “Wow! Can’t believe I found you!” This conversation can continue until John and/or Joanna decide to meet in person.

In some implementations, in response to transitioning to the chatroom interface, the two users, John and Joanna, can communicate with one another over live streaming and/or video chats. Specifically, John and Joanna can communicate with one another over a video and/or audio chat. Additionally John or Joanna can initiate a live stream and the other user can join and watch the live stream.

Other examples of individuals meeting can be also be realized by this system. In some examples, a user can seek to identify more than one individual through the lost and found function. In another example, a user can seek to connect with an individual not found on the social networking application. By seeking to connect with the individual not found on the social networking application, the server 104 can request the individual join the social networking application to communicate with the requesting user. Alternatively, the requesting user may seek to communicate with the individual outside the social networking application.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer-readable medium for execution by, or to control the operation of, data processing apparatus. The computer readable medium may be a non-transitory computer readable storage medium, a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a server, a request from a first client device associated with a first user to enter a lost and found function in a social networking application;
obtaining, by the server from the first client device, one or more items that describe a prior encounter between the first user and a different user;
identifying, by the server, one or more potential candidates from among a plurality of potential candidates in the lost and found function that match to the different user, the one or more potential candidates identified by comparing characteristics for each candidate of the plurality of potential candidates to the obtained one or more items;
providing, by the server, data indicative of the one or more potential candidates to the first client device, wherein the data indicative of the one or more potential candidates includes a first set of information describing each of the potential candidates;
receiving, by the server, a connection request to one potential candidate of the one or more potential candidates from the first client device;
transmitting, by the server, a first notification to a second client device associated with the one potential candidate, the first notification comprising (i) an indication that the first user associated with the first client device requests to open a communication channel with the second client device of the one candidate and (ii) a second set of information describing the first user;
receiving, by the server, a second notification from the second client device indicating the one potential candidate requests to reveal a third set of information to the first user;
transmitting, by the server, a third notification to the first client device, the third notification comprising the third set of information describing the one potential candidate; and
receiving, by the server, a request from the first client device to match with the second client device and open the communication channel.

2. The computer-implemented method of claim 1, wherein obtaining the one or more items that describe a prior encounter between the first user and the different user comprises:
providing, by the server, a user interface to the first client device for the lost and found function that enables the first user to search for other users based on information about the prior encounter associated with the other users; and
obtaining, by the server, the one or more items that describe the prior encounter between the first user and the different user, wherein the first user provides the one or items as input into the user interface and the one or more items comprises at least one of a name of the different user, a school attended by the different user, a last known location of the different user, an age range of the different user, interests of the different user, and other information defining the different user, and the different user shared the prior encounter with the first user.

3. The computer-implemented method of claim 1, wherein identifying the one or more potential candidates from among the plurality of potential candidates in the lost and found function that match to the different user, the one or more potential candidates identified by comparing characteristics for each candidate of the plurality of potential candidates to the obtained one or more items provided by the first client device, the method further comprises:
obtaining, by the server, a profile for each candidate of the plurality of potential candidates from a database, each candidate of the plurality of the potential candidates (i) having an associated client device and (ii) associated with the social networking application;
for each candidate of the plurality of potential candidates:
comparing, by the server, the one or more obtained items from the first client device to the characteristics in the profile of the candidate;
in response to comparing, determining, by the server, a percent match between the one or more obtained items and the characteristics in the profile of each candidate;
comparing, by the server, the percent match to a threshold value; and
in response to determining the percent match for the candidate is greater than the threshold value, identifying, by the server, the candidate as a potential candidate.

4. The computer-implemented method of claim 3, wherein the data indicative of the potential candidates includes a first set of information describing the potential candidate, wherein the first set of information comprises (i) a name of the potential candidate, (ii) a school of the potential candidate, (iii) a last known location of the potential candidate and the date the potential candidate was at that location, and (iv) other information pertaining to the potential candidate.

5. The computer-implemented method of claim 3, comprising:
in response to receiving the connection request to the one potential candidate from the first client device, identifying, by the server, the second client device associated with the one potential candidate by identifying the one potential candidate in the database and the second client device; and
obtaining, by the server, the second set of information describing the first user, wherein the second set of information comprises (i) a name of the first user, (ii) a photograph of the first user, (iii) biographical information of the first user.

6. The computer-implemented method of claim 5, wherein transmitting the first notification to the second client device associated with the one candidate further comprises:
transmitting, by the server, the first notification to the second client device, the second notification comprising (i) the indication that the first user associated with the first client device requests to open the communication channel between the first client device and the second client device, (ii) the second set of information describing the first user, and (iii) a second indication for the second user to either (i) decline the request for opening the communication channel or (ii) reveal additional profile information of the second user to the first user.

7. The computer-implemented method of claim 6, wherein receiving the second notification from the second client device indicating the one potential candidate request to reveal the third set of information with the first user further comprises:
identifying, by the server, the third set of information for the second user from the database, wherein the third set of information is different from the first set of information for the second user, wherein the server identifies the third set of information from a profile corresponding to the second user.

8. The computer-implemented method of claim 1, wherein receiving the request from the first client device to match with the second client device and open the communication channel further comprises:
receiving, by the server, the request from the first client device to match with the second client device, the request indicating that the first user recognizes the one potential candidate as a potential match for the different user from the prior encounter.

9. A system comprising:
one or more computers and one or more storage devices storing instructions that are operable, when executed by the one or more computers, to cause the one or more computers to perform operations comprising:
receiving, by a server, a request from a first client device associated with a first user to enter a lost and found function in a social networking application;
obtaining, by the server, one or more items that describe a prior encounter between the first user and a different user;
identifying, by the server, one or more potential candidates from among a plurality of potential candidates in the lost and found function that match to the different user, the one or more potential candidates identified by comparing characteristics for each candidate of the plurality of potential candidates to the obtained one or more items provided by the first client device;
providing, by the server, data indicative of the one or more potential candidates to the first client device, wherein the data indicative of the one or more potential candidates includes a first set of information describing each of the potential candidates;
receiving, by the server, a connection request to one potential candidate of the one or more potential candidates from the first client device;
transmitting, by the server, a first notification to a second client device associated with the one potential candidate, the first notification comprising (i) an indication that the first user associated with the first client device requests to open a communication channel with the second client device of the one candidate and (ii) a second set of information describing the first user;
receiving, by the server, a second notification from the second client device indicating the one potential candidate requests to reveal a third set of information to the first user;
transmitting, by the server, a third notification to the first client device, the third notification comprising the third set of information describing the one potential candidate; and
receiving, by the server, a request from the first client device to match with the second client device and open the communication channel.

10. The system of claim 9, wherein obtaining the one or more items that describe a prior encounter between the first user and the different user comprises:
providing, by the server, a user interface to the first client device for the lost and found function that enables the first user to search for other users based on information about the prior encounter associated with the other users; and
obtaining, by the server, the one or more items that describe the prior encounter between the first user and the different user, wherein the first user provides the one or items as input into the user interface and the one or more items comprises at least one of a name of the different user, a school attended by the different user, a last known location of the different user, an age range of the different user, interests of the different user, and other information defining the different user, and the different user shared the prior encounter with the first user.

11. The system of claim 9, wherein identifying the one or more potential candidates from among the plurality of potential candidates in the lost and found function that match to the different user, the one or more potential candidates identified by comparing characteristics for each candidate of the plurality of potential candidates to the obtained one or more items provided by the first client device, the method further comprises:
obtaining, by the server, a profile for each candidate of the plurality of potential candidates from a database, each candidate of the plurality of the potential candidates (i) having an associated client device and (ii) associated with the social networking application;
for each candidate of the plurality of potential candidates:
comparing, by the server, the one or more obtained items from the first client device to the characteristics in the profile of the candidate;
in response to comparing, determining, by the server, a percent match between the one or more obtained items and the characteristics in the profile of each candidate;
comparing, by the server, the percent match to a threshold value; and
in response to determining the percent match for the candidate is greater than the threshold value, identifying, by the server, the candidate as a potential candidate.

12. The system of claim 11, wherein the data indicative of the potential candidates includes a first set of information describing the potential candidate, wherein the first set of information comprises (i) a name of the potential candidate, (ii) a school of the potential candidate, (iii) a last known location of the potential candidate and the date the potential candidate was at that location, and (iv) other information pertaining to the potential candidate.

13. The system of claim 11, comprising:
in response to receiving the connection request to the one potential candidate from the first client device, identifying, by the server, the second client device associated with the one potential candidate by identifying the one potential candidate in the database and the second client device; and
obtaining, by the server, the second set of information describing the first user, wherein the second set of information comprises (i) a name of the first user, (ii) a photograph of the first user, (iii) biographical information of the first user.

14. The system of claim 13, wherein transmitting the first notification to the second client device associated with the one candidate further comprises:
transmitting, by the server, the first notification to the second client device, the second notification comprising (i) the indication that the first user associated with the first client device requests to open the communication channel between the first client device and the second client device, (ii) the second set of information describing the first user, and (iii) a second indication for the second user to either (i) decline the request for opening the communication channel or (ii) reveal additional profile information of the second user to the first user.

15. The system of claim 14, wherein receiving the second notification from the second client device indicating the one potential candidate request to reveal the third set of information with the first user further comprises:
identifying, by the server, the third set of information for the second user from the database, wherein the third set of information is different from the first set of information for the second user, wherein the server identifies the third set of information from a profile corresponding to the second user.

16. The system of claim 9, wherein receiving the request from the first client device to match with the second client device and open the communication channel further comprises:
receiving, by the server, the request from the first client device to match with the second client device, the request indicating that the first user recognizes the one potential candidate as a potential match for the different user from the prior encounter.

17. A non-transitory computer-readable medium storing software comprising instructions executable by one or more computers which, upon such execution, cause the one or more computers to perform operations comprising:
receiving, by a server, a request from a first client device associated with a first user to enter a lost and found function in a social networking application;
obtaining, by the server, one or more items that describe a prior encounter between the first user and a different user;
identifying, by the server, one or more potential candidates from among a plurality of potential candidates in the lost and found function that match to the different user, the one or more potential candidates identified by comparing characteristics for each candidate of the plurality of potential candidates to the obtained one or more items provided by the first client device;
providing, by the server, data indicative of the one or more potential candidates to the first client device, wherein the data indicative of the one or more potential candidates includes a first set of information describing each of the potential candidates;
receiving, by the server, a connection request to one potential candidate of the one or more potential candidates from the first client device;
transmitting, by the server, a first notification to a second client device associated with the one potential candidate, the first notification comprising (i) an indication that the first user associated with the first client device requests to open a communication channel with the second client device of the one candidate and (ii) a second set of information describing the first user;
receiving, by the server, a second notification from the second client device indicating the one potential candidate requests to reveal a third set of information to the first user;
transmitting, by the server, a third notification to the first client device, the third notification comprising the third set of information describing the one potential candidate; and receiving, by the server, a request from the first client device to match with the second client device and open the communication channel.

18. The non-transitory computer-readable medium of claim 17, wherein obtaining the one or more items that describe a prior encounter between the first user and the different user comprises:
providing, by the server, a user interface to the first client device for the lost and found function that enables the first user to search for other users based on information about the prior encounter associated with the other users; and
obtaining, by the server, the one or more items that describe the prior encounter between the first user and the different user, wherein the first user provides the one or items as input into the user interface and the one or more items comprises at least one of a name of the different user, a school attended by the different user, a last known location of the different user, an age range of the different user, interests of the different user, and other information defining the different user, and the different user shared the prior encounter with the first user.

19. The non-transitory computer-readable medium of claim 17, wherein identifying the one or more potential candidates from among the plurality of potential candidates in the lost and found function that match to the different user, the one or more potential candidates identified by comparing characteristics for each candidate of the plurality of potential candidates to the obtained one or more items provided by the first client device, the method further comprises:
obtaining, by the server, a profile for each candidate of the plurality of potential candidates from a database, each candidate of the plurality of the potential candidates (i) having an associated client device and (ii) associated with the social networking application;
for each candidate of the plurality of potential candidates:
comparing, by the server, the one or more obtained items from the first client device to the characteristics in the profile of the candidate;
in response to comparing, determining, by the server, a percent match between the one or more obtained items and the characteristics in the profile of each candidate;
comparing, by the server, the percent match to a threshold value; and
in response to determining the percent match for the candidate is greater than the threshold value, identifying, by the server, the candidate as a potential candidate.

20. The non-transitory computer-readable medium of claim 19, wherein the data indicative of the potential candidates includes a first set of information describing the potential candidate, wherein the first set of information comprises (i) a name of the potential candidate, (ii) a school of the potential candidate, (iii) a last known location of the potential candidate and the date the potential candidate was at that location, and (iv) other information pertaining to the potential candidate.
